(19) United States
(12) Patent Application Publication
(10) Pub. No.: US 2007/0202262 A1
(43) Pub. Date: Aug. 30, 2007

(54) Process For Producing Coated Portions Of Woven Fabric

(75) Inventor: Markus Gottschalk, Hildesheim (DE)

Correspondence Address: SYNNESTVEDT & LECHNER, LLP, 1101 MARKET STREET, 26TH FLOOR, PHILADELPHIA, PA, 19107-2950, US

(73) Assignee: AUTOMOTIVE SAFETY COMPONENTS INTERNATIONAL GMBH &, Hildesheim (DE)

(21) Appl. No.: 10/599,703

(22) PCT Filed: Feb. 23, 2002
(86) PCT No.: PCT/EP05/03076

§ 371 Date: Oct. 5, 2006

(30) Foreign Application Priority Data
Apr. 6, 2004 (DE) 10 2004 016 798.2

(51) Int. Cl. B32B 27/02; B32B 25/02; B05D 3/02

(52) U.S. Cl. 427/385.5; 442/164; 442/280

(57) ABSTRACT

A process for producing individual portions of the airbag of an airbag system which consist of silicone-coated woven fabric is characterized in that, in succession, the contours of the individual portions to be produced are cut out of a woven fabric web in a cutting station, these individual portions being coated in a coating station (8) selectively in a step resembling screen printing, and the coated individual portions being thereafter subjected to a thermal treatment in a heating station for the purpose of crosslinking. Compared with the available prior art, the advantages which result are lower losses of comparatively costly silicone and also a more homogeneous waste which is simpler to deal with in waste-engineering terms, since it consists of uncoated woven fabric only.

This invention concerns a process as categorized in the preamble of claim 1.

Coated portions of woven fabric are used for example, but not exclusively, in the production of airbags for airbag systems. These airbags consist in general of a plurality of individual portions which after they have been produced, namely cut to size and coated, have to be joined together. The individual portions are produced from a woven fabric coated with silicone rubber because of a need for strength, heat resistance, gas impermeability and desired properties of elasticity.

It is known within the assignee company to produce these individual portions of the airbag by proceeding from a reel of wound-up web of woven fabric, the web being continuously unreeled and processed. A horizontally guided section of the web of woven fabric is coated on its topside, over its entire width, with a silicone rubber which is flowable in its original state and which, after smoothing by means of a squeegee, is subjected to heating/vulcanization. The individual portions needed to produce the airbag are subsequently cut out of the coated vulcanized woven fabric using a laser-cutting range for example, while the remaining areal sections of the coated woven fabric web are disposed of as scrap. The coated individual portions are subsequently joined together to produce the airbag.

Silicone or silicone rubber is a comparatively costly starting material. This fact is particularly disadvantageous in relation to the above-described method of operation, since such products are produced in large amounts and the resulting fraction of scrap generally accounts for about 20% to 30% by weight of the coated woven fabric. The operation thus produces considerable amounts of scrap which is difficult to dispose of and possibly re-use because it constitutes a heterogeneous composition of matter.

An airbag occasionally utilizes different woven fabric styles and/or woven fabrics of different silicone weight. The known process, however, provides scarcely any real opportunity for the silicone weight to be varied according to the individual portion. Waste is thus generated that differs in the type of the woven fabric and of the silicone weight.

Against this background, it is an object of the present invention to develop a process of the type identified at the beginning in the direction of improved scope for varying the product, a reduction in the amount of waste generated and also a homogenization in the waste generated.

We have found that this object is achieved for such a process by the features of the characterizing portion of claim 1.

It is accordingly essential to the present invention that, in departure from the prior art discussed at the beginning, the woven fabric web is only coated with a coating composition selectively, namely according to the sheetlike extent of the individual portions cut out of the woven fabric web. As a result, scrap is only generated in the form of uncoated woven fabric, considerably simplifying any disposal engineering. Material is saved with regard to coating composition in accordance with the costs for the coating composition and also for the scrap quantity which is geometrically dictated with regard to the area of the woven fabric web. Variations become realizable in the coating weight for the individual portions in accordance with the properties desired for the coated individual portions in that the coating thickness itself can be individually varied for each individual portion. As a consequence of the homogeneity of the scrap, there is no need for separating operations for recovering individual, in particular utilizable, components.

The features of claim 2 are directed to a concrete realization of a selective coating of the individual portions. The conventional screen printing process is used. Any version of the screen printing process can in principle be used, including flat screen printing, cylinder screen printing, rotary screen printing or else electrostatic screen printing, to mention but a few examples. What is essential in all cases is that a screen comprises areal fractions which are permeable and impermeable to the coating composition and whose size, shape and position is conformed to the individual portions to be coated and to be cut out of the woven fabric web, so that the coating composition only arrives on the individual portions through the permeable areal fractions. There is thus no generation of coated scrap.

The features of claims 3 to 5 are directed to an advantageous use of the process of the present invention, namely for producing the silicone-coated individual portions of the airbag of an airbag system, which are subsequently joined together in a conventional manner to produce the airbag. If necessary, individual portions comprising woven fabric having differing coating weights can be produced in a simple manner. In principle, hot- and cold-vulcanizing silicones can be used, in particular with regard to their high heat resistance, flame protection and also their elasticity which is substantially constant over a wide temperature range.

The present invention further has for its object to provide apparatus for carrying out this process as categorized in the preamble of claim 6. We have found that this object is achieved in relation to such a process by the features of the characterizing portion of claim 6.

The apparatus thereby consists of the consecutive arrangement of a cutting station, a coating station and a heating station, which are connected with each other via conveying systems. The apparatus can be designed for continuous operation whose starting materials consists of coated portions of woven fabric and uncoated portions of woven fabric to be regarded as waste. The apparatus offers cost advantages through the possibility of saving coating material and through the simpler handling of the waste generated substantially in terms of material. The apparatus further offers technical advantages with regard to the simple coating thickness individually conformed to the individual portion to be coated.

The present invention will now be more particularly elucidated with regard to the illustrated process flow scheme for producing the airbag of an airbag system in the drawings, where:

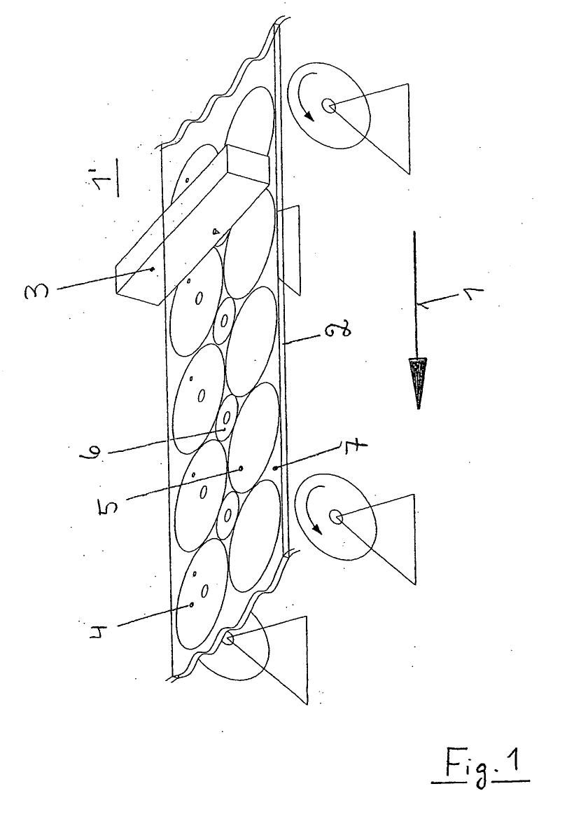

FIG. 1 shows the cutting to size of the individual portions of an airbag in the original state;

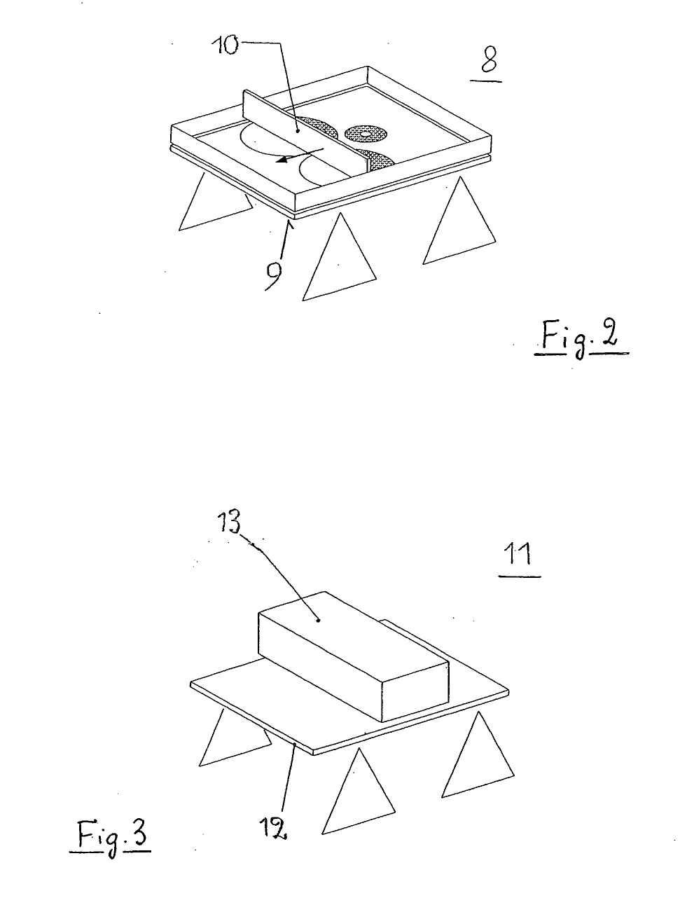

FIG. 2 shows the siliconizing of the woven fabric;

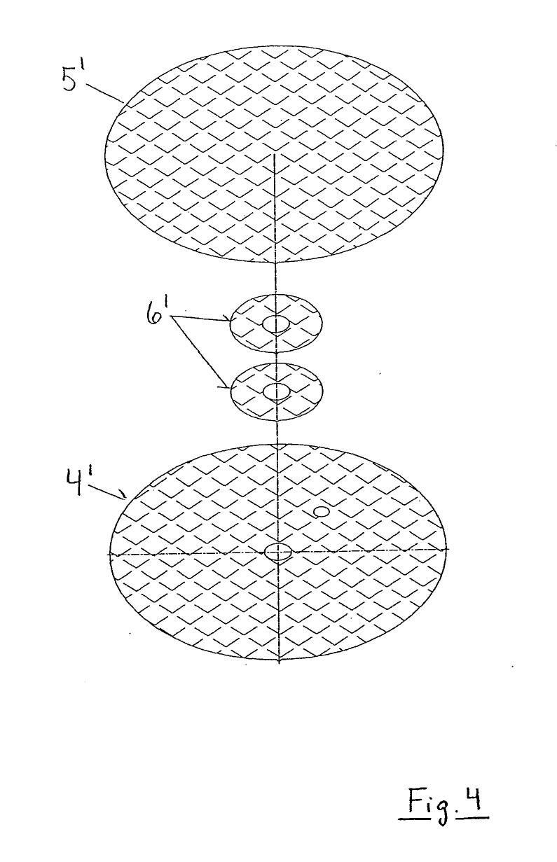

FIG. 3 shows the drying of the coated fabric;

FIG. 4 shows a representation of the ready-produced individual portions to be joined together to produce an airbag.

The starting point for the process of the present invention is shown in FIG. 1 to be a web moving horizontally in the direction of arrow 1, uniformly or else cyclically, preferably in a cutting station 1′, which consists of a woven fabric 2 and is being unwound off a reel not shown. The forward feed for the web can be provided in any desired manner in engineering terms, and will not be more particularly discussed hereinbelow.

A cutting apparatus 3, for example a laser-cutting apparatus, cuts out of the plane of the web individual portions 4, 5, 6 whose contours and other constitution correspond to the individual portions of the airbag which are to be joined together.

In a subsequent step, still within the cutting station 1′, the individual portions 4, 5, 6 are separated from the remaining portions 7 of the woven fabric 2, and the latter are discarded as waste. The individual portions 4, 5, 6 subsequently pass into a coating station 8, depicted schematically in FIG. 2, for applying a silicone layer.

This coating station 8 is fitted out according to the functional principle, known from printing technology, of the screen printing process. The individual portions 4, 5, 6 resting at defined positions on a planar horizontal support 9 have placed on them a finely meshed sieve onto which is applied silicone rubber in flowable or brushable consistency and smoothed by means of a squeegee 10. The constitution of the sieve is such that it comprises areal fractions, through which the silicone rubber passes, and such areal fractions as are covered up or stopped, so that no silicone rubber can pass through.

The individual portions 4, 5, 6 are positioned on the support 9 such that the permeable areal fractions of the sieve are situated above these individual portions. The permeable areal fractions are conformed to the specified individual portions with regard to the area and also geometrically. The mesh size of the sieve and the viscosity of the silicone rubber as coating composition are chosen to the effect that this composition is pressed through the permeable areal fractions and depicts them geometrically on the individual portions.

The exit product of coating station 8 is thus individual portions 4, 5, 6 coated with a layer of silicone rubber. These are subsequently fed, for crosslinking or drying, to a heating station 11 depicted schematically in FIG. 3. The coated individual portions rest on a support 12 above which a heating appliance 13 is situated. A crosslinking reaction ensues in accordance with the type of silicone used.

The exit products of heating station 11 are the ready-produced individual portions 4′, 5′, 6′ which are shown in FIG. 4 in their contours by way of example and which thus consist of a silicone-coated woven fabric, and these individual portions are subsequently joined together in a conventional manner to produce the airbag.

The cutting station (1′), the coating station (8) and also the heating station each form stages of a unitary process which are connected to each other via conveying systems not depicted.

1. A process for producing sheetlike individual portions (4′, 5′, 6′) consisting of woven fabric (2) and coated with an originally flow- or brushable coating composition by proceeding from a reel of wound-up woven fabric web, characterized in that the uncoated individual portions (4, 5, 6) are cut out of the woven fabric web and the remaining residual portions (7) of the woven fabric web are discarded as waste, in that the individual portions (4, 5, 6) are placed on a support (9) and underneath a sieve such that they are situated underneath areal fractions of the sieve which are permeable to the coating composition and which sieve is otherwise impermeable, and in that the coating composition is applied to the sieve and is transferred to the individual portions through the areal fractions designed and arranged to be equiareal to the individual portions (4, 5, 6) to be coated.

2. The process according to claim 1 that is characterized in that a silicone rubber is used as coating composition.

3. The process according to claim 1 that is characterized in that the mass of coating composition applied is individually adjusted for every individual portion (4′, 5′, 6′).

4. The use of a process according to claim 1 for producing individual portions (4′, 5′, 6′) of the airbag of an airbag system which consists of a silicone-coated woven fabric.

5. Apparatus for carrying out the process according to claim 1, characterized by the consecutive arrangement, in the direction of material flow, of a cutting station (1′) adapted for cutting to size individual portions (4, 5, 6) out of a woven fabric web and for discarding residual portions (7) of the woven fabric web, a coating station (8) for transferring the coating composition and a heating station (11) for treating the coating composition.

6. The process according to claim 2 that is characterized in that the mass of coating composition applied is individually adjusted for every individual portion (4′, 5′, 6′).

7. The use of a process according to claim 2 for producing individual portions (4′, 5′, 6′) of the airbag of an airbag system which consists of a silicone-coated woven fabric.

8. The use of a process according to claim 3 for producing individual portions (4′, 5′, 6′) of the airbag of an airbag system which consists of a silicone-coated woven fabric.

9. Apparatus for carrying out the process according to claim 2, characterized by the consecutive arrangement, in the direction of material flow, of a cutting station (1′) adapted for cutting to size individual portions (4, 5, 6) out of a woven fabric web and for discarding residual portions (7) of the woven fabric web, a coating station (8) for transferring the coating composition and a heating station (11) for treating the coating composition.

10. Apparatus for carrying out the process according to claim 3, characterized by the consecutive arrangement, in the direction of material flow, of a cutting station (1′) adapted for cutting to size individual portions (4, 5, 6) out of a woven fabric web and for discarding residual portions (7) of the woven fabric web, a coating station (8) for transferring the coating composition and a heating station (11) for treating the coating composition.

11. Apparatus for carrying out the process according to claim 4, characterized by the consecutive arrangement, in the direction of material flow, of a cutting station (1′) adapted for cutting to size individual portions (4, 5, 6) out of a woven fabric web and for discarding residual portions (7) of the woven fabric web, a coating station (8) for transferring the coating composition and a heating station (11) for treating the coating composition.
